(19) United States
(12) Patent Application Publication
(10) Pub. No.: US 2017/0173992 A1
(43) Pub. Date: Jun. 22, 2017

(54) Filing Cabinet Divider Mat

(71) Applicant: Leonard Kutney, Red Lake (CA)

(72) Inventor: Leonard Kutney, Red Lake (CA)

(21) Appl. No.: 15/389,035

(22) Filed: Dec. 22, 2016

Related U.S. Application Data
(60) Provisional application No. 62/270,791, filed on Dec. 22, 2015.

(51) Int. Cl. B42F 17/12; A47B 88/969; A47B 63/00; A47B 88/919

(52) U.S. Cl. CPC B42F 17/12; A47B 88/919; A47B 88/969; A47B 63/00

(57) ABSTRACT

A filing cabinet divider mat. The filing cabinet divider mat features a rectangular flat panel having a top surface and a bottom surface. A plurality of parallel ridges is positioned on the top surface, running perpendicular to the longitudinal axis of the flat panel. The ridges extend vertically from the top surface of the flat panel and may range in height from 0.001 to 2 inches, allowing a folder to be easily adjusted within a drawer without having to be fully lifted and removed, while still holding the bottom of the folder in place. An adhesive material is placed on the bottom surface to securely affix the flat panel to the bottom of a filing cabinet drawer.

### CROSS REFERENCE TO RELATED APPLICATIONS

This application claims the benefit of U.S. Provisional Application No. 62/270,791 filed on Dec. 22, 2015. The above identified patent application is herein incorporated by reference in its entirety to provide continuity of disclosure.

### BACKGROUND OF THE INVENTION

The present invention relates to filing cabinet accessories. More specifically, the present invention relates to file cabinet dividers that are configured to organize files within a cabinet drawer and ensure that they to do not shift or move into undesired positions.

Filing cabinets are ubiquitous to office life and are found in large corporations, small home offices and everywhere in between. The drawers of a filing cabinet are design to hold large amounts of documents in file folders that are placed in an upright position within the drawer. Some filing cabinets feature a track to keep folders suspended upright. However, these require use of special folders designed with hooks to hang on the track. Other filing cabinets are designed for folders to simply be placed within the drawer interior. These drawers can be difficult to organize when only partially full. While a full drawer will have enough folders to support each other, starting a file cabinet drawer can be particularly difficult, as the folder slide and easily topple over. Additionally, even if a file cabinet drawer is already full with a sufficient number of folders to offer proper support, occasionally users have a need to remove a number of folders, leaving the remaining folders unsupported and susceptible to falling over.

Large vertical dividers can be placed at various positions within a drawer, but they can be cumbersome to install or adjust, leaving a user struggling to make the most efficient use of his filing cabinet drawer. Accordingly, a filing cabinet divider that is unobtrusive and designed to offer support for individual folders is desired.

### SUMMARY OF THE INVENTION

In view of the foregoing disadvantages inherent in the known types of filing cabinet drawer dividers now present in the prior art, the present invention provides a filing cabinet divider mat wherein the same can be utilized for providing convenience for the user when organizing a filing cabinet drawer. The present system comprises a flat panel having a plurality of parallel ridges disposed on the top surface thereof. The ridges extend vertically from the top surface and may range in height from 0.001 to 2 inches, allowing a folder to be easily adjusted without having to fully lift and remove the folders while still holding the bottom of the folder in place.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the top surface of one embodiment of the filing cabinet divider mat.

FIG. 2 shows a perspective view of the bottom surface of one embodiment of the filing cabinet divider mat showing an adhesive backing.

FIG. 3 shows a side elevational view of the ridges of one embodiment of the filing cabinet divider mat.

FIG. 4 shows a perspective view of the filing cabinet divider mat installed within a filing cabinet drawer.

### DETAILED DESCRIPTION OF THE INVENTION

Reference is made herein to the attached drawings. Like reference numerals are used throughout the drawings to depict like or similar elements of the filing cabinet divider. The figures are intended for representative purposes only and should not be considered to be limiting in any respect.

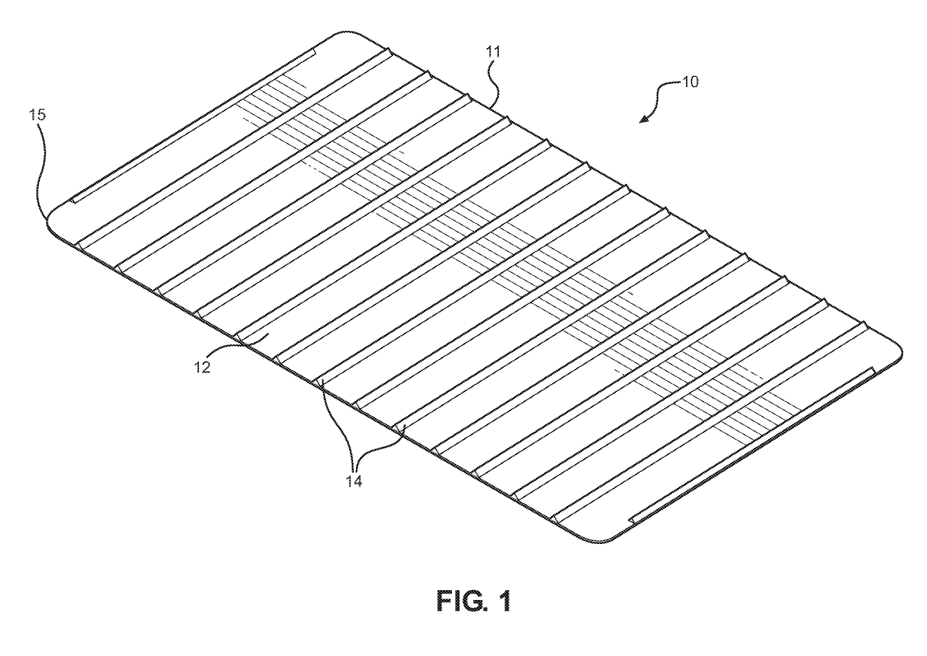

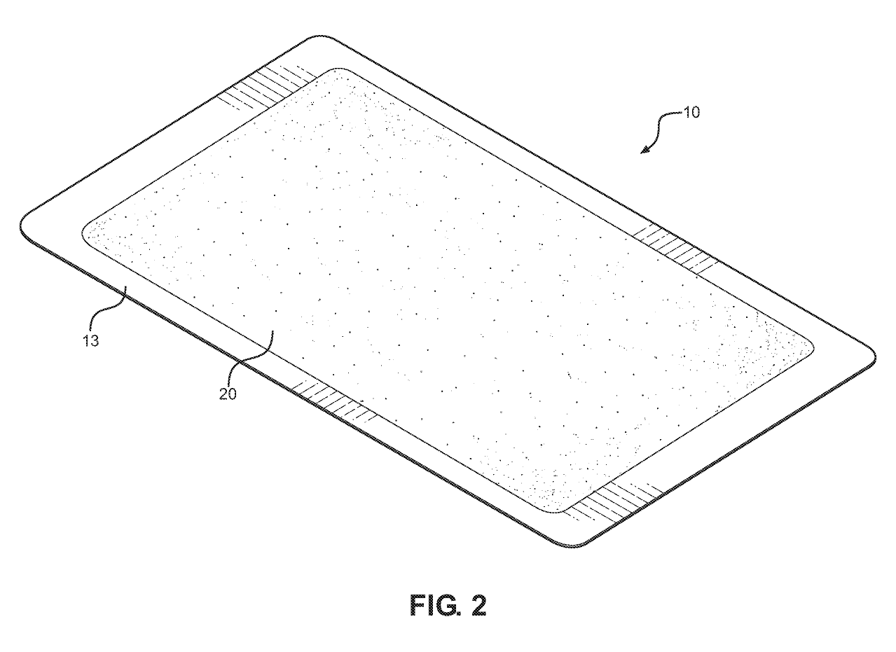

Referring now to FIGS. 1 and 2, there is shown a perspective view of the top surface and a perspective view of the bottom surface of one embodiment of the filing cabinet divider mat, respectively. The filing cabinet divider mat 10 comprises a substantially rectangular flat panel 11 having a top surface 12 and a bottom surface 13 and a plurality of ridges 14 placed thereon. In some embodiments of the filing cabinet divider mat 10, the corners 15 of the flat panel 11 further comprise rounded edges for easy handling. In a further embodiment, the flat panel 11 comprises flexible material, such as a polymer plastic, that it can be easily rolled up into a compact cylinder for convenient transportation.

The ridges 14 of the filing cabinet divider mat 10 are arranged at regularly spaced intervals and are parallel to each other. The longitudinal axis of the ridges 14 is perpendicular to the longitudinal axis, of the rectangular flat panel 11 on a top surface 12 thereof 12. The ridges 14 extend vertically upward from the flat panel 11 and are configured to prevent the bottom edge of a file from undesired movement. In one embodiment of the filing cabinet divider mat 10, the ridges 14 are disposed along the full width of the flat panel 11.

An adhesive material 29 is secured to the bottom surface 13 of the filing cabinet divider mat 10. The adhesive material 29 is configured to be permanently affixed to the base of a filling cabinet drawer, such that once the filing cabinet divider mat 10 is installed, it is securely held in place. In some embodiments, the adhesive material 29 covers at least 75% of the bottom surface 13 of the flat panel 11, providing increased surface contact with a drawer base, for enhance security. In further embodiments, a protective backing is placed on the adhesive material 20 and is configured to be easily peeled off. The protective backing provides a barrier between the adhesive material 20 and the surrounding environment, ensuring that no foreign matter become lodged on the surface of the adhesive material 20 until the filing cabinet divider mat 10 is ready to be installed in the desired filing cabinet drawer.

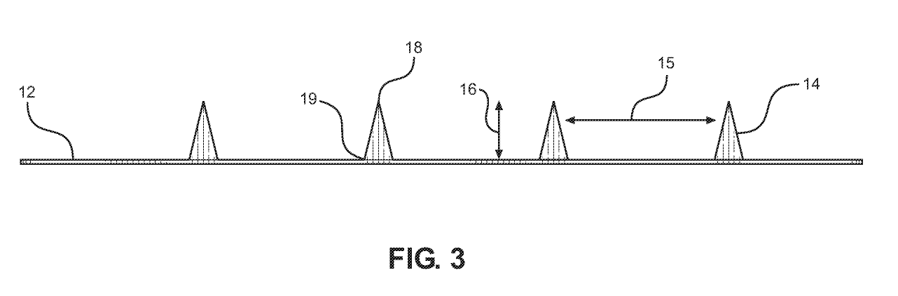

Referring now FIG. 3, there is shown a side elevational view of the ridges of one embodiment of the filing cabinet divider mat 10. In one embodiment, the side profile of a cross section of each ridge 14 comprises an inverted V-shape having a wider base 19 with sidewalk that extend away from the top surface 12 and coming to a point 18 at the top. This shape is designed to direct the bottom of a file to either a front side or a rear side of the ridge 14, while securely holding the folder in place and preventing it from shifting position.

The height 16 of the point 18 relative to the top surface 12 of the flat panel 11 can vary according to a user's needs. For example, the ridge height 16 may range from 0.001 to 2 inches, depending on the type of files or folders to be used. Additionally, the number of ridges 14 present on the top surface 12 can vary. The spacing 15 between the ridges 14 may vary as well, and is dependent on the longitudinal length and the number of ridges placed thereon. In one embodiment, fifteen ridges are evenly positioned along the longitudinal of the top surface 12 of the flat panel 11.

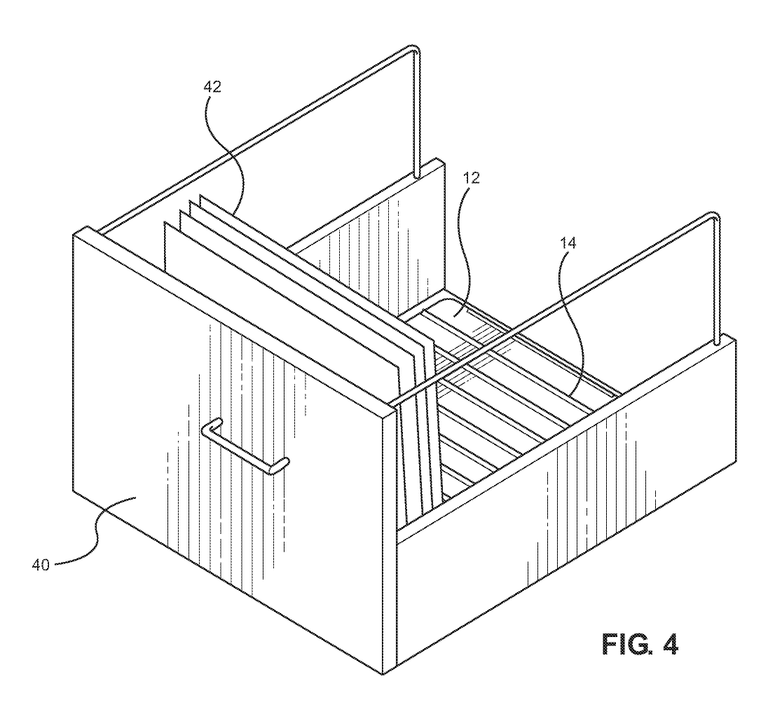

Referring now to FIG. 4, there is a shown a perspective view of the filing cabinet divider mat installed within a filing cabinet. In use, the filing cabinet divider mat 12 is installed on the base of a filing cabinet drawer 40 and held in place by the adhesive material. Files can be placed within the drawer 40 and kept in place by the sidewalks of the ridges 14. The filing cabinet divider mat is an ideal organizational tool when a user is beginning to fill up a filing cabinet drawer and only has a few folders to place therein.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A filing cabinet divider mat, comprising:
a rectangular flat panel having a top surface and a bottom surface;
a plurality of parallel ridges disposed on the top surface, wherein the plurality of parallel ridges are positioned perpendicular to the longitudinal axis of the flat panel;
an adhesive material disposed on the bottom surface of the flat panel and configured to securely affix the flat panel to a drawer base.

2) The filing cabinet divider mat of claim 1, wherein corners of the flat panel are rounded.

3) The filing cabinet divider mat of claim 1, wherein the plurality of parallel ridges extend vertically from the top surface.

4) The filing cabinet divider mat of claim 1, wherein the cross section of the plurality of parallel ridges is an inverse V shape, having a wider base and coming to a pointed top.

5) The filing cabinet divider mat of claim 4, the height between the pointed top of the plurality of parallel ridges and the top surface of the flat panel is between 0.001 and 2 inches.

6) The filing cabinet divider mat of claim 1, wherein the flat panel comprises a flexible material and that is configured to roll into a compact cylinder.

7) The filing cabinet divider mat of claim 1, wherein the adhesive material covers at least 75% of the bottom surface.

8) The filing cabinet divider mat of claim 1, further including a filing cabinet drawer dimensioned to fit the filing cabinet divider therein.
